(19) United States
(12) Patent Application Publication
(10) Pub. No.: US 2002/0073188 A1
(43) Pub. Date: Jun. 13, 2002

(54) Method and apparatus for partitioning system management information for a server farm among a plurality of leaseholds

(76) Inventor: Freeman Leigh Rawson III, Austin, TX (US)

Correspondence Address: Duke W. Yee, Carstens, Yee & Cahoon, LLP, P.O. Box 802334, Dallas, TX, 75380, US

(21) Appl. No.: 09/731,615

(22) Filed: Dec. 7, 2000

(51) Int. Cl. G06F 15/173

(52) U.S. Cl. 709/223; 709/225

(57) ABSTRACT

A method and apparatus are provided by which system management information is partitioned and provided to customers of a thin server farm. With the method and apparatus, a thin server manager is utilized to aggregate system management information for a plurality of customers of a thin server farm. The aggregated system management information is then partitioned into documents for each customer and provided to adapters for the customers' agents. The adapters translate the documents into a form useable by the agents which then provide the information contained in the documents to the customers' management system software. Correspondingly, the customers' management software may generate commands that are sent through the agents and adapters, converted to commands to the thin server manager and, with appropriate controls, are executed against the resources controlled by the particular customer whose management system sent the commands.

### RELATED APPLICATION

The present invention is related to commonly assigned and co-pending U.S. patent application Ser. No. ______ (Attorney Docket No. AUS920000416US1) entitled “METHOD AND APPARATUS FOR TIME DECAY MONITORING OF APPLICATION, NETWORK AND SYSTEM BEHAVIOR,” filed on even date herewith, and which is hereby incorporated by reference.

### BACKGROUND OF THE INVENTION

1. Technical Field

The present invention is in the general area of computing systems and information technology and is directed more specifically to the management of a large number of such systems where the systems are divided among a number of different customers. The present invention is directed to a method and apparatus for partitioning system management information for such a server farm among a plurality of -customers.

2. Description of Related Art

Thin servers or server appliances have been developed to provide specialized servers that are typically cheaper and easier to install and use than traditional server computer systems. The terms thin server and server appliance are essentially synonymous and are used interchangeably throughout the balance of this document. A thin server is a network-based computer specialized for some function such as print serving, ISDN routing, web serving or network attached storage (NAS). Web server software is often built in allowing management and control via a Web browser residing on any client platform in the network although that is not a necessary feature.

Farms or clusters of thin servers are being used to provide web-based application services as a single system from an administrative and management perspective while maintaining multiple execution images. For a variety of reasons including bandwidth access, cost reduction and flexibility, many web-based applications are being hosted on thin server farms, or clusters, which are owned and/or operated by other groups, and in turn, these groups may lease portions of the facility to a number of different customers. When a server farm is split among multiple end customers, each of whom has contractually defined rights to service from the hardware and software in the farm, the farm is described as being partitioned into leases or leaseholds.

In known farms, all management function is performed by the owner or operator of the farm on behalf of all of its customers. A standardized report is then generated and provided to each of the customers. The standardized report provides information that may not be easily used by the customers since the standardized report is not specific to each customer. The report is also static and does not allow for direct and interactive management of the resources within the farm as a part of the customers' overall information technology infrastructures using the customers' previously established management tools and methodologies. Accordingly, it would be beneficial to have a method and apparatus for partitioning system management information for a server farm among a plurality of leaseholds in such a manner as to facilitate the use of the individual customers' pre-existing system management tools.

### SUMMARY OF THE INVENTION

The present invention provides a method and apparatus for partitioning system management information among a plurality of leaseholds. With the method and apparatus of the present invention, a thin server farm is operated as a shared or leaseable facility. As such, the customers using the shared facility execute their server applications on the servers that they lease and provide system management agents that run on a thin server manager, which may be implemented as part of a management server appliance for the thin server farm, for example. The agents gather management information and perform management functions on the portion of the shared facility that they are currently using.

With the present invention, the thin server manager aggregates all of the information about the applications, the network and the systems in the network. The thin server manager is also given a set of information, which may be in the form of extended markup language (XML) documents, that describes the leases that are in force and the service-level agreements of contractually defined obligations associated with each of the leases. The thin server manager has, as part of its management information base, the current assignments of resources to each leaseholder, the status of each lease, and how the resources are being used, e.g., what applications are being run under the lease, on how many servers the applications are being run, how much network bandwidth is being used, the level of success of running the applications, and the like. Based on this information, the thin server manager creates for each lease a computer-processable document in a form, such as XML, that it forwards to an adapter for each of the leaseholder agents.

The adapters and the leaseholder agents may all run on a management server appliance or metaserver system or be on different systems. Each adapter acts as a translation layer, converting the document to a format which the leaseholder's agent can handle. The document contains only the information about the leased resources rather than a full picture of the facility.

If the leaseholder's system management software issues a command to some entity within the leased portion of the server farm, the command is translated by the adapter to a document parsable by the thin server manager. The thin server manager determines if the command is an appropriate command, makes any required translations or restrictions, and then forwards it to one or more agents within the leasehold.

The present invention offers, among others, three major advantages in the operation of server farms, especially ones using thin servers or server appliances. First, the present invention provides a mechanism for a single server appliance to manage multiple sets of appliances where each set is being used by a different customer of the server farm or for a different purpose. Second, the present invention allows each customer of the thin server farm to use the customer's own system management infrastructure to manage its portion of the thin server farm as an extension of the information technology systems that the customer owns or already has. Third, the invention eliminates the cumbersome and often usable reports that are typically generated by a service provider or server farm operator for its customers. Other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a distributed data processing system according to the present invention;

FIG. 2 is an exemplary block diagram illustrating one embodiment of the thin server manager according to the present invention; and

FIG. 3 is a flowchart outlining an exemplary operation of the present invention.

### DETAILED DESCRIPTION OF THE PREFERRED EMBODIMENT

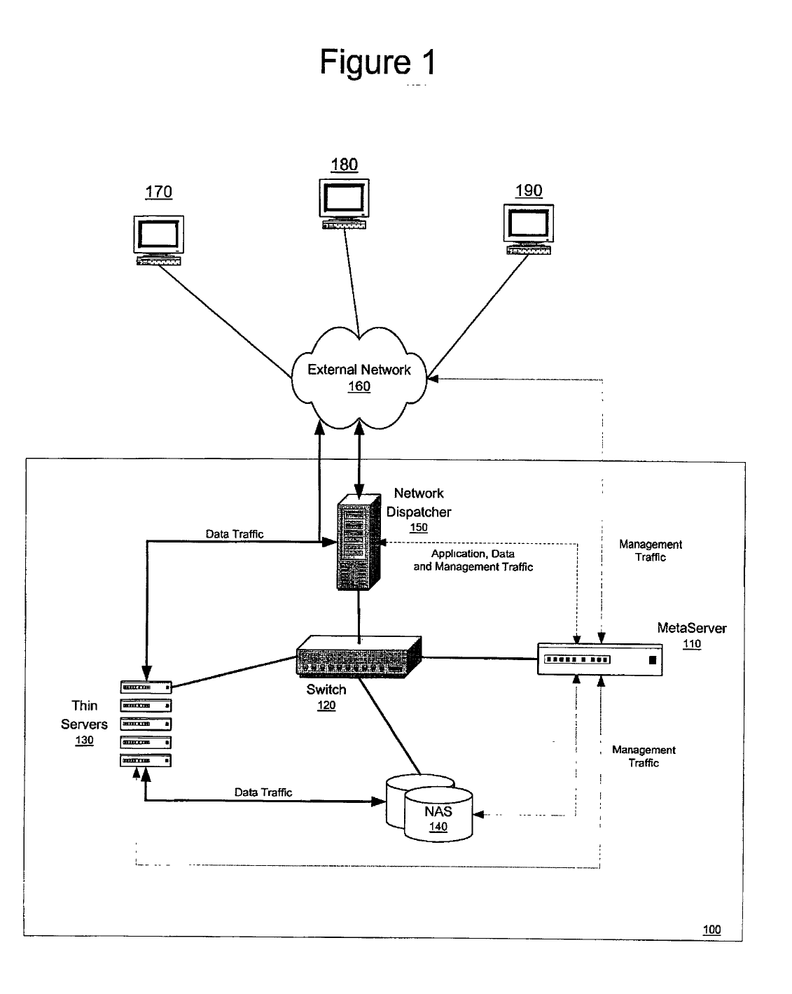

FIG. 1 is an exemplary block diagram illustrating a distributed data processing system according to the present invention. As shown in FIG. 1, the distributed data processing system includes a metaserver 110, a switch 120, one or more thin servers 130, network attached storage (NAS) 140, network dispatcher 150, external network 160, and one or more client devices 170-190. The metaserver 110, switch 120, thin servers 130, NAS 140 and network dispatcher 150 are part of a local area network 100 coupled to the external network 160. In FIG. 1, data flow is denoted by lines having arrow heads while actual physical connections are denoted by solid lines. In actuality, all data packets are routed through the switch 120.

The distributed data processing system shown in FIG. 1 is illustrative only. The particular architecture and elements shown in FIG. 1 are not intended to place any limitations on the architecture and elements used with the present invention. Rather, the distributed data processing system may have many other architectures and may include other elements in addition to, or in replacement of, the elements shown in FIG. 1 without departing from the spirit and scope of the present invention.

In the data processing system of FIG. 1, the thin servers 130 provide specialized applications to client devices 170-190 via the external network 160 and the network dispatcher 150. The thin servers 130 may provide any number of different applications, including print applications, database applications, web-serving applications, and the like.

The external network 160 may be any type of data network known to those of ordinary skill in the art. The external network 160 may be, for example, the Internet, an intranet, a wide area network (WAN), local area network (LAN), wireless data network, satellite data network, or the like. The external network 160 may also be any combination of the above.

The client devices 170-190 may be any type of computing device capable of accessing the thin servers 130 via the external network 160 and the network dispatcher 150. The client devices 170-190 may be, for example, a personal computer, laptop computer, personal digital assistant (PDA), data network capable wireless communication device, and the like. The client devices 170-190 may access applications provided by the thin servers 130 using, for example, a web browser application or the like.

The network dispatcher 150 performs workload balancing with regard to the thin servers 130 with the goal being to avoid looking at every packet, especially every packet sent back by the thin servers 130. The network dispatcher 150 dispatches jobs or transaction requests to the thin servers 130 and the NAS 140. The network dispatcher 150 essentially provides a mechanism through which job or transaction requests may be sent to applications running on the thin servers 130 The responses to these job or transaction requests are supplied directly by the thin servers 130 through the switch 120 to the external network 160 and hence to the clients 170-190.

The NAS 140 is a specialized file server that connects to the network. The NAS 140 uses traditional local area network (LAN) protocols, such as Ethernet and TCP/IP and processes only file I/O requests such as Network File System (NFS)(UNIX) and Server Message Block (SMB)(DOS/Windows).

The switch 120 is an electronic device that directs the flow of data from one side of the switch to the other. The switch 120 may be any type of data switching device known to those of ordinary skill in the art. For example, the switch 120 may be an Ethernet switch, a hub, a router, or the like. The switch 120 serves to route data and message traffic to appropriate devices 110, 130, 140 and 150.

The metaserver 110 performs the function of managing the devices in the local area network, e.g., the switch 120, the thin servers 130, the NAS 140 and the network dispatcher 150. In managing these devices, what is meant is that the metaserver 110 performs management functions including collecting data to maintain statistics of historical interest and to monitor the current state of the devices. The metaserver 110 may be a server, as is generally known in the art, or may be a specialized thin server that is used to perform management functions. In the depicted example, the metaserver 110 is a specialized thin server.

The present invention provides a mechanism by which system management information is partitioned and provided to customers of a server farm. With the present invention, a thin server manager is utilized to aggregate system management information for a plurality of customers of a server farm. The aggregated system management information is then partitioned into sets, one for each leasehold, and provided to adapters of the leaseholder agents in a form that is susceptible to automated computer processing. An example of such a form is a valid XML document with a well-defined document type definition.

The adapters translate the received set into a form useable by the leaseholder agents, which then interact with the customer's management system. Thus, the customer's management system software, which is typically purchased from a vendor and may represent a substantial investment, does not need to be changed.

The management server appliance, or metaserver, shown in FIG. 1 operates based on instructions stored in local memory or storage. These instructions may include, for example, computer program instructions for implementing the thin server manager of the present invention. Alternatively, the thin server manager, as will be described hereafter, may be implemented as a hardware component of the metaserver, as software instructions, or a combination of hardware and software.

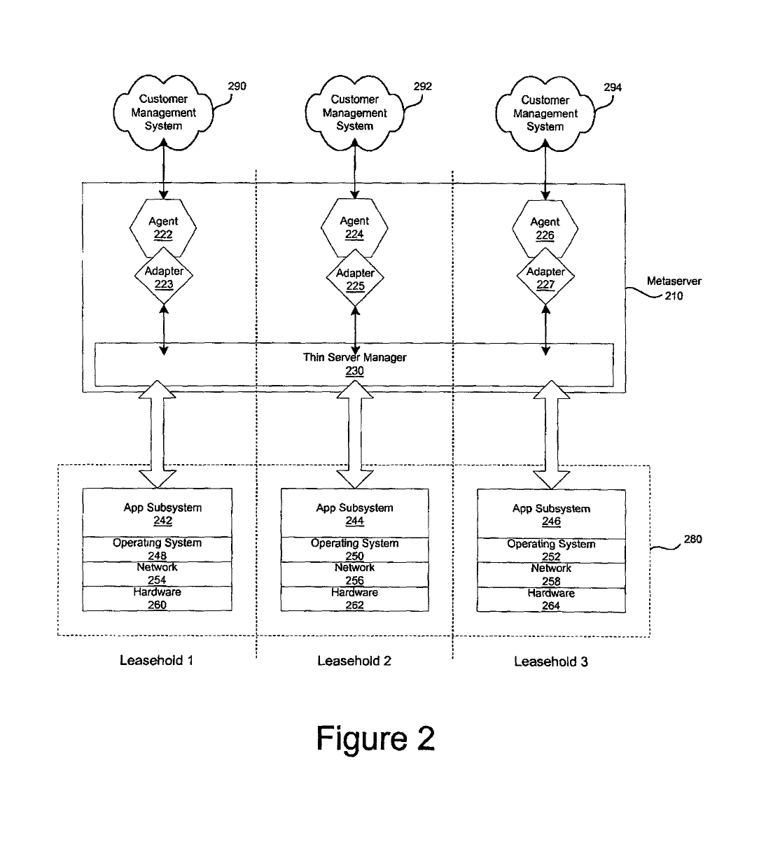

FIG. 2 is an exemplary block diagram illustrating a thin server manager according to the present invention. As shown in FIG. 2, the metaserver (or other management server) 210 includes a plurality of leasehold agents 222, 224, 226, a thin server manager 230, and a plurality of adapters 223, 225, 227 coupled to respective agents 222, 224, 226 and the thin server manager 230.

The thin server manager 230 aggregates system management information from the application subsystems 242, 244 and 246, operating systems 248, 250 and 252, network interfaces 254, 256 and 258, and hardware 260, 262 and 264, of the individual servers of the thin server farm 280 for each of a plurality of leaseholds.

The aggregated system management information may include, for example, the assignment of resources to each leaseholder, the status of each lease, and how the resources are being used. For example, the aggregated system management information may include an identification of the applications run under the lease, the number of thin servers on which the applications for each lease were run, the amount of network bandwidth used by each lease, the level of success of running the applications, and the like. The aggregated system management information may include other management information in addition to, or in replacement of, the management information described above.

In a preferred embodiment, system management information may be obtained from the thin server farm 280 by sending requests from thin server manager 230 to the systems being managed and receiving the system management information in response to the systems having received the requests. The request and response messages passed between the thin server manager 230 and the managed systems are, in a preferred embodiment, in an extensible Markup Language (XML) format, although other formats may be used without departing from the spirit and scope of the present invention.

The thin server manager 230 aggregates this system management information and then partitions the system management information into system management information sets for each of the plurality of leaseholds. In partitioning the system management information, the thin server manager 230 uses the lease information, to identify each of the leaseholds and the corresponding system management information. The lease information may be provided to the thin server manager 230 in a parsable format, such as an extensible markup language (XML) document, or the like.

For example, each leasehold may be represented in the thin server manager 230 by a set of data structures that point to the resources owned by that leasehold, the resources (such as NAS, for example) sub-allocated to the leasehold, and information about each of these owned and sub-allocated resources. Based on the information stored in these data structures, correlation of the leasehold with management information from the various managed systems, i.e. resources, may be performed.

The partitioned system management information is then used to generate a document for each of the leaseholds. The document is preferably in a well-defined format that is readily processed by computer programs, such as an XML document, or the like. The documents may be generated at predetermined times, such as daily, weekly, monthly or the like, may be generated based on the occurrence of certain events or the completion of certain activities, or may be generated when instructed to do so by an administrator, or the like. Documents directed to different agents for different leaseholds may be generated at different times, depending on the particular needs of the customer.

The agents 222, 224, 226 may include, integrated therein, adapters 223, 225, and 227 for the customer management systems. Alternatively, the adapters 223, 225 and 227 may be separate devices or virtual entities present in the metaserver 210. There is at least one adapter 223, 225 and 227 for each of the leaseholds managed by the thin server manager 230.

The adapters 223, 225 and 227 receive the documents generated by the thin server manager 230 and act as a translation layer for the agents of the customer management systems 222, 224 and 226. The adapters 223, 225 and 227 parse the received documents and convert them to the form handled by the corresponding agents 222, 224, 226. For example, the adapter may receive the document in an XML format and convert the document to an application program interface (API) calls, remote program calls (RPCs), or the like.

The converted document is then used by the customer's management system 290, 292, 294 to perform system management functions. These system management functions may include sending commands to applications running on the thin server farm. If commands are received from the customer's management system 290, 292 or 294, the commands are received by the agents 222, 224, 226 and converted into a form usable by the thin server manager 230, preferably a document in a format such as XML. The thin server manager 230 then determines if the command is an appropriate command, and if so, makes any necessary translations or restrictions and forwards the command to the application. Commands are considered appropriate if they do not interfere with other leases or affect the overall operation of the server farm.

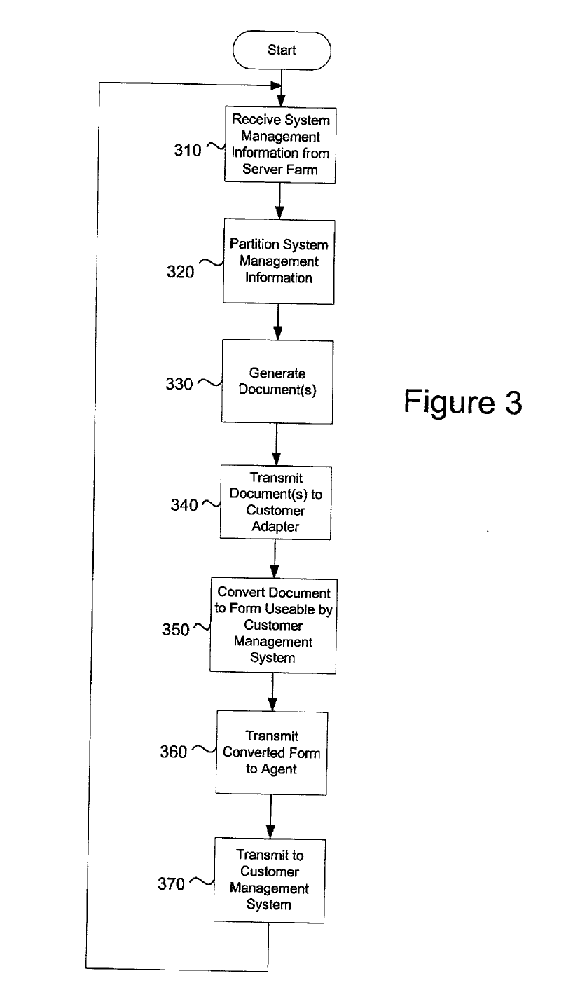

FIG. 3 is a flowchart outlining an exemplary operation of the present invention. As shown in FIG. 3, the operation starts with receiving system management information from the thin server farm (step 310). The system management information is partitioned (step 320) and a document is generated for each of the leaseholds (step 330). The documents are then transmitted to a customer's management system adapter (step 340). The adapter converts the document into a form useable by the customer's management system (step 350) and transmits the converted form of the document to the agent of the customer (step 360). The agent then operates normally sending the information to be processed by the customer's management system (step 370). The operation then returns to step 310 to wait for the next set of information from the server farm.

Thus, the present invention provides a mechanism by which system management information from a thin server farm may be partitioned for use by a plurality of individual customer leaseholders. Each customer may use its own management system to receive the partitioned information and perform necessary management functions. Thus, there is no need to incorporate additional functionality into the customer's management system to accommodate managing applications and systems within a server farm at a service provider's site.

While the present invention has been described in terms of managing applications and systems in a thin server farm, the present invention is equally applicable to management of any “farm” of network appliances and devices. For example, the present invention may be utilized with a farm of regular servers, application servers, or the like. The use of a farm of thin servers in the description of the preferred embodiments is for illustrative purposes only and is not meant to place any limitations on the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal-bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of partitioning system management information for a plurality of network devices, comprising:
receiving system management information for the plurality of network devices; and
partitioning the system management information based on at least one leasehold of the plurality of network devices.

2. The method of claim 1, further comprising:
generating at least one document based on the partitioned system management information for each of the at least one leasehold; and
transmitting the at least one document to a management system of the at least one leasehold.

3. The method of claim 2, wherein transmitting the at least one document includes converting the document to a format useable by the management system.

4. The method of claim 3, wherein converting the document includes translating the document from an extensible markup language document to one of an application program interface format and a remote program call format.

5. The method of claim 1, wherein partitioning the system management information includes partitioning the system management information based on stored lease information.

6. The method of claim 5, wherein the stored lease information is received as an extensible markup language document.

7. The method of claim 2, wherein transmitting the at least one document includes sending the at least one document to a management system adapter that converts the document to a format useable by the management system.

8. The method of claim 1, wherein the system management information includes at least one of an identification of applications run under each of the at least one leasehold, a number of network devices on which the applications for each of the at least one leasehold were run, an amount of network bandwidth used by each of the at least one leasehold, and a level of success of running the applications under each of the at least one leasehold.

9. The method of claim 1, wherein the plurality of network devices are a plurality of thin servers in a thin server farm.

10. The method of claim 1, wherein the plurality of network devices are a plurality of thin servers and wherein the method is implemented in a metaserver of a thin server farm.

11. An apparatus for partitioning system management information for a plurality of network devices, comprising:
means for receiving system management information for the plurality of network devices; and
means for partitioning the system management information based on at least one leasehold of the plurality of network devices.

12. The apparatus of claim 11, further comprising:
means for generating at least one document based on the partitioned system management information for each of the at least one leasehold; and
means for transmitting the at least one document to a management system of the at least one leasehold.

13. The apparatus of claim 12, wherein the means for transmitting the at least one document includes means for converting the document to a format useable by the management system.

14. The apparatus of claim 13, wherein the means for converting the document includes means for translating the document from an extensible markup language document to one of an application program interface format and a remote program call format.

15. The apparatus of claim 11, wherein the means for partitioning the system management information includes means for partitioning the system management information based on stored lease information.

16. The apparatus of claim 15, wherein the stored lease information is received as an extensible markup language document.

17. The apparatus of claim 12, wherein means for transmitting the at least one document includes means for sending the at least one document to a management system adapter that converts the document to a format useable by the management system.

18. The apparatus of claim 11, wherein the system management information includes at least one of an identification of applications run under each of the at least one leasehold, a number of network devices on which the applications for each of the at least one leasehold were run, an amount of network bandwidth used by each of the at least one leasehold, and a level of success of running the applications under each of the at least one leasehold.

19. The apparatus of claim 11, wherein the plurality of network devices are a plurality of thin servers in a thin server farm.

20. The apparatus of claim 11, wherein the plurality of network devices are a plurality of thin servers and wherein the apparatus is a metaserver.

21. A computer program product in a computer readable medium for partitioning system management information for a plurality of network devices, comprising:
first instructions for receiving system management information for the plurality of network devices; and
second instructions for partitioning the system management information based on at least one leasehold of the plurality of network devices.

22. The computer program product of claim 21, further comprising:
third instructions for generating at least one document based on the partitioned system management information for each of the at least one leasehold; and
fourth instructions for transmitting the at least one document to a management system of the at least one leasehold.

23. The computer program product of claim 22, wherein the fourth instructions for transmitting the at least one document includes instructions for converting the document to a format useable by the management system.

24. The computer program product of claim 23, wherein the instructions for converting the document includes instructions for translating the document from an extensible markup language document to one of an application program interface format and a remote program call format.

25. The computer program product of claim 21, wherein the second instructions for partitioning the system management information includes instructions for partitioning the system management information based on stored lease information.

26. The computer program product of claim 25, wherein the stored lease information is received as an extensible markup language document.

27. The computer program product of claim 22, wherein the fourth instructions for transmitting the at least one document includes instructions for sending the at least one document to a management system adapter that converts the document to a format useable by the management system.

28. The computer program product of claim 21, wherein the system management information includes at least one of an identification of applications run under each of the at least one leasehold, a number of network devices on which the applications for each of the at least one leasehold were run, an amount of network bandwidth used by each of the at least one leasehold, and a level of success of running the applications under each of the at least one leasehold.

29. The computer program product of claim 21, wherein the plurality of network devices are a plurality of thin servers in a thin server farm.

30. The computer program product of claim 21, wherein the plurality of network devices are a plurality of thin servers and wherein the computer program product is executed in a metaserver of a thin server farm.
